(19) United States
(12) Patent Application Publication
(10) Pub. No.: US 2006/0091673 A1
(43) Pub. Date: May 4, 2006

(54) Plumbing apparatus

(75) Inventors: Gary K. Weise, Plancentia, CA (US); Richard J. Kesl, Plancentia, CA (US)

Correspondence Address: Terry L. Miller, 24832 Via San Fernando, Mission Viejo, CA, 92692, US

(73) Assignee: Thermocraft Industries, Inc.

(21) Appl. No.: 10/979,444

(22) Filed: Nov. 1, 2004

(51) Int. Cl. F16L 39/00

(52) U.S. Cl. 285/125.1

(57) ABSTRACT

The present invention provides a plumbing apparatus that includes an offset or tangential T-fitting providing for offsetting a branch pipe from a run pipe in end elevation view, and for the branch pipe to intersect the run pipe orthogonally in side elevation view. That is, the branch pipe may intersect the run pipe substantially tangentially, so that an arrangement of plumbing fittings and devices may be nested into a thinner wall or into a smaller dimension of space than would be the case if a conventional T-fitting were employed. By use of the inventive T-fitting a considerable savings in materials of construction may be realized in the construction of swimming pools and spas, for example. Particularly, the present inventive offset or tangential T-fitting provides for the installation of bubble jet fittings and associated piping into a comparatively thin (i.e., about 6 inches thick) dam wall between a swimming pool and spa.

### BACKGROUND OF THE INVENTION

The present invention relates generally to a plumbing apparatus, and particularly to a plumbing apparatus or fitting for use with water. More particularly, the present invention relates to a plumbing fitting generally of T-configuration for forming a part of a water circulation system. The inventive plumbing fitting is particularly useful in a water circulation system for a swimming pool, hot tub, or spa, for example.

In spas that are adjacent to a pool, it is conventional to have a wall between and common to both the pool and the spa. Such a common shared wall is generally referred to as a “dam wall.” The dam wall of a pool/spa is generally only about six inches (15.24 cm) thick in order to use the generally available size of decorative tile. In such cases, the generally available plumbing fittings make it very difficult or impossible to install bubble jets in the dam wall. In order to allow the installation of bubble jets in the dam wall, some pool/spa installations undesirably use a dam wall that is thicker than six inches. In such cases, the dam wall may be as thick as nine inches (22.86 cm) or even twelve inches (30.48 cm). Such a thick dam wall necessitates an increase in the materials used to construct the pool/spa, and increases the costs of materials and construction.

Also, when bubble jets are installed in the dam wall or in the other walls of a spa or pool, they are necessarily close to the reinforcing bars (i.e., “rebar”) required in these walls to reinforce and prevent cracking of the concrete. Conventionally, each such bubble jet is supplied with air from one manifold pipe embedded in the spa or pool wall; and from another manifold pipe also embedded in the spa or pool wall the bubble jet fitting is supplied with pressurized water to drive the jet of bubbly water. As a result, even when these relatively large manifold pipes are spaced adjacent to the reinforcing bars, the walls of the spa or pool must be made thicker than is desired in order to provide sufficient material into which the plumbing pipes and fittings can be embedded. Accordingly, the use of construction materials, especially the use of concrete to construct the pool walls, increases as a result of the conventional configuration of plumbing fittings.

Particularly, this increased use of construction materials is the case because that extra thickness of the pool or spa walls which is necessary simply to accommodate the plumbing pipes and fittings is generally carried over to other parts of the pool or spa wall as well. That is, even though many other parts of the spa or pool walls do not include plumbing fittings, they are nevertheless made thicker than would otherwise be necessary. As a result, the undesirably increased wall thickness for the pool wall which occurs because of the embedded plumbing fittings also appears over all or a substantial portion of the pool, greatly increasing the amount of concrete required for pool construction.

As can be seen, there is a need for an improved plumbing T-fitting that may be installed within a comparatively thin dam wall, such as within a six-inch dam wall, as often is desired for a spa, pool, and the like.

Also, there is a need for an improved plumbing T-fitting that may be installed close to reinforcing bar of a pool or spa wall, so as to allow the pool wall to be constructed thinner and to us less concrete than is required by conventional plumbing fittings of T-configuration.

### SUMMARY OF THE INVENTION

In view of the deficiencies of the conventional technology, an objective for this invention is to reduce or eliminate one or more of these deficiencies.

Accordingly, as realized in one particularly preferred exemplary embodiment, the present invention provides a tangential T-fitting having a through passage which at each of its opposite ends is provided with features for connecting the T-fitting into a manifold pipe at a pool or spa. For example, the T-fitting may be provided with a pair of threaded bore sections, one at each end and opening in opposite directions to facilitate connection in a run of threaded pipe to the tangential T-fitting. Alternatively, the tangential T-fitting may include simple cylindrical sockets for use with an adhesively bonded pipe construction, such as is commonly used with PVC pipe, so that the tangential T-fitting may be connected or bonded into a run of PVC pipe.

The tangential T-fitting is provided with at least one other connection feature, which is arranged offset from the centerline of the through passage. This offset connection may be arranged to be substantially tangential with the through passage. Accordingly, the tangential T-fitting provides for a connection to the run of pipe which is offset or tangential to this run of pipe. By use of such an offset connection, the run of pipe may be spaced closer to rebar or other structure embedded in a concrete wall, and the wall may be made thinner and use less concrete than would otherwise be possible.

These and other aspects, objects, features and advantages of the present invention will become clear from a reading of the following detailed description of exemplary preferred embodiments of the invention when considered in conjunction with the accompanying drawings.

### BRIEF DESCRIPTION OF THE DRAWINGS

FIG. 1 is an end elevation view, partially in cross section, of a plumbing fitting, according to an embodiment of the present invention;

FIG. 2 is a fragmentary side elevation view of the plumbing fitting seen in FIG. 1, and is taken in the direction of arrows 2-2 on FIG. 1;

FIG. 3 is the fragmentary side elevation view, partially in cross section, taken at the plane of line 3-3 on FIG. 1, and looking in the direction of the arrows;

FIG. 4 is an end elevation view, similar to the view of FIG. 1, shows the tangential T-fitting apart from its connected to a run of piping in order to improve clarity of illustration of the inventive fitting; and

FIG. 5 provides a perspective view of an alternative embodiment of the tangential T-fitting of this invention, which embodiment provides for plural offset connections to the same T-fitting.

### DETAILED DESCRIPTION OF THE INVENTION

The following detailed description provides a disclosure of the best currently contemplated modes of carrying out the invention. The description is not to be taken as a limitation on the invention, but is provided merely for the purpose of illustrating exemplary particularly preferred embodiments of the invention, and by so doing, to bring forth the general principles of the invention. The spirit and scope of the invention is defined by the appended claims.

A T-fitting, herein generally referred to as a “tangential T-fitting” is useful for installing plumbing fittings into a space which is smaller than the space needed for conventional T-fittings. That is, space is gained by use of the present invention because other plumbing fittings and pipes which are attached to the tangential T-fitting, can be arranged or “nested” to better take advantage of available space. As a result, the plumbing fitting according to this invention may be installed within a six-inch dam wall such as is often desired for a spa or pool.

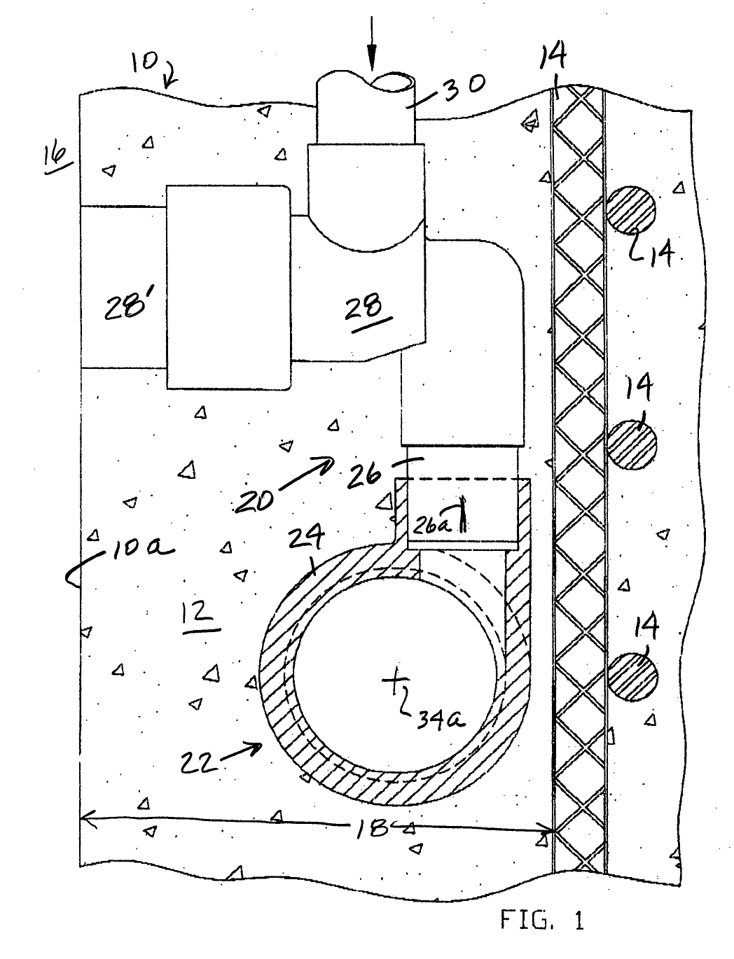

In more specifically describing the present invention, and as can be appreciated from FIG. 1, a wall structure 10, such as a wall or a swimming pool or spa, includes a body 12 of concrete (i.e., cement and aggregate), and an array of reinforcing bars 14 (only one of which is seen in FIG. 1). On one side of the wall 10, the surface 10a is exposed to water 16 to a level above that shown by this Figure. The wall 10 may be exposed also to water or to earth, for example, toward the right hand side of this wall (not seen in the drawing Figures). However, it is to be noted that the lateral dimension or space 18 between the reinforcing bar 14 and the surface 10a is somewhat limited. In fact, it is desired to make this dimension 10a smaller than is conventionally possible, because doing so will reduce the amount of concrete required to construct the wall 10. However, as is seen in FIG. 1, the wall 10 also includes a plumbing arrangement, generally indicated with the arrowed numeral 20.

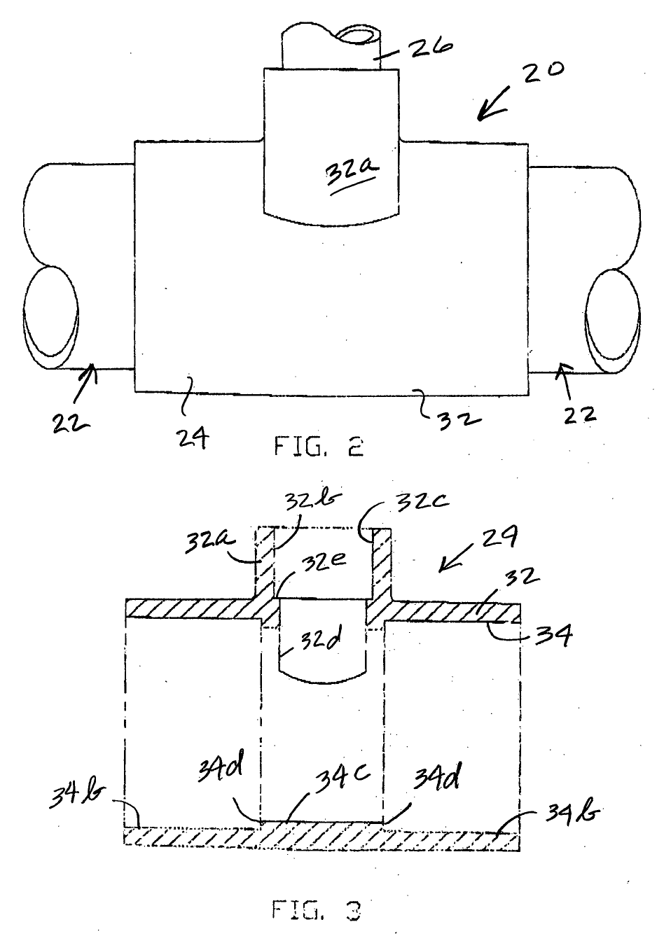

The plumbing arrangement 20 includes a lower water manifold pipeline (indicated with the arrowed numeral 22—and best viewed in FIG. 2), a tangential T-fitting 24 in the pipeline 22, a connecting branch pipe 26, extending from the fitting 24 to a bubble jet fitting 28, an exit nipple 28′ extending from the fitting 28 to the surface 10a, and an upper connecting pipe 30. Those ordinarily skilled in the pertinent arts will appreciate that the upper connecting pipe 30 extends downwardly to the fitting 28 from an upper air manifold pipeline (not seen in the drawing Figures), which is similar to the water pipeline 22.

However, examination of the tangential T-fitting 24 will reveal that it includes a body 32 defining a through passage 34 communicating the pipeline flow for the pipe 22. This through passage 34 has a center line 34a, and it will be noted that the connecting branch pipe 26 is tangential at one side to the passage 34, and is offset at its center line 26a from the center line 34a. As is seen in FIG. 1, because the tangential T-fitting allows the centerline 34a of pipeline 22 to be offset relative to the connecting branch pipe 26, and toward surface 10a, this pipeline 22 is commensurately moved away from the position it would otherwise occupy relative to the reinforcing bar 14. Because the plumbing arrangement 20 can thus be nested in the available space 18 between the rebar 14 and surface 10a, the dimension 18 can be made smaller than would be the case were a conventional T-fitting used in the pipeline 22.

Further considering FIGS. 1, 2, and 3, it is seen that the body 32 of the tangential T-fitting 24 defines bore 34 as a stepped through bore having a centerline 34a, and a pair of larger diameter sections 34b, as well as a centrally disposed smaller diameter section 34c. The sections 34b and 34c of bore 34 cooperatively define a pair of oppositely disposed shoulders 34d on the bore 34. Those ordinarily skilled in the pertinent arts will appreciate that the bore portions 34b provide pipe sockets into which the termination end portions of adjacent runs of PVC pipe may be adhesively bonded. In this context, the shoulders 34d define the extent or limit of the penetration of the end portions of the adjacent pipe runs into the pipe sockets of the tangential T-fitting 32.

Similarly, the tangential T-fitting 32 includes an orthogonally disposed cylindrical boss 32a which is offset from the centerline 34a of the passage 34 (recalling FIG. 1). As is best seen in FIGS. 1 and 3, this cylindrical boss 32a defines a stepped through bore 32b. The stepped bore 32b includes a larger diameter section 32c, and a smaller diameter section 32d. These sections 32c and 32d cooperatively define an outwardly disposed shoulder 32e, so that the cylindrical boss 32a also provides a pipe socket for adhesively receiving and bonding of an orthogonally disposed branch pipe, such as the branch pipe 26 seen in FIG. 1.

It will be noted viewing FIG. 1, that the right hand side of the bore section 32d is substantially tangential to the bore 34. Accordingly, the centerlines 26a and 34a of the pipes 26 and 22 do not intersect or align with one another in an end elevation view (i.e., FIG. 1) of the plumbing arrangement 20. However, as is seen in FIG. 2, the centerlines 26a and 34a do intersect orthogonally in side elevation view. Consequently, the space or distance 18 seen in FIG. 1 can be made smaller than would be the case were a conventional T-fitting use in the plumbing arrangement 20.

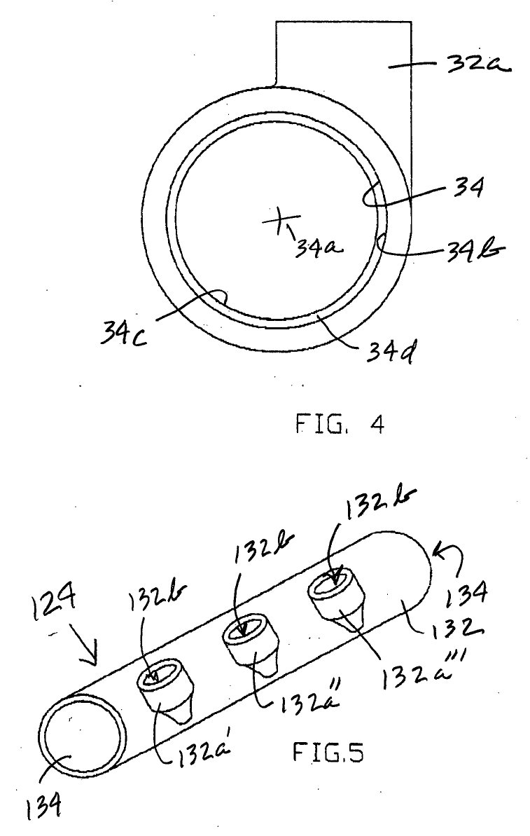

Turning now to FIG. 5, an alternative embodiment of the Tangential T-fitting according to this invention is illustrated in perspective view. Because this alternative embodiment of the invention has many features in common with the first embodiment described above, features of the alternative embodiment which are the same or analogous in structure or function to those described above are indicated on FIG. 5 with the same numeral used above but increased by one-hundred (100). As is seen in FIG. 5, a tangential T-fitting 124 includes a pair of opposed pipe sockets, each indicated with the numeral 134, and only one of which is seen directly in FIG. 5. This tangential T-fitting 124 includes a body 132, and plural (in this case 3, although the invention is not so limited) offset bosses 132a (with the individual bosses 132a being distinguished by having one or more primes added to the reference numeral). Each boss 132a provides a pipe socket 132b (with the individual sockets 132b being distinguished by having one or more primes added to the reference numeral). Thus, the tangential T-fitting seen in FIG. 5 provides for three connections to the main pipeline passing along the pipes connecting into sockets 134. The three connections (one at each of sockets 132b) are each offset toward the viewer of FIG. 5 to a tangential position like that illustrated in FIG. 4. In fact, those ordinarily skilled in the pertinent arts will recognize that the end elevation view provided in FIG. 4 applies equally to the first embodiment illustrated in FIGS. 1-3, and to the second embodiment of FIG. 5.

Accordingly, the present invention provides a tangential T-fitting which has advantageous application to the installation of plumbing arrangements, such as for example, the arrangement 20 seen in FIG. 1, although the invention is not so limited. The embodiment of FIGS. 1-4 provides for a single offset connection of a branch pipeline to a run pipeline, while the embodiment of FIG. 5 provides for plural branch pipelines to be connected to a run pipeline each in an offset relationship. While it is clear in the illustrations provided that the branch pipeline connections at cylindrical bosses 32a or 132a are tangential at one side to the passage of the pipeline 22 within the fitting, this need not be the case. That is, the branch connections can be offset as little (but a non-zero amount) or as much as is desired, up to the limit of being tangential at one side with the through passage of the fitting. Accordingly, it is to be understood that the phrase “tangential T-fitting” properly applies only to the non-limiting exemplary preferred embodiments, and that a more general term could also be used to describe a T-fitting according to this invention. That more general term would be “offset T-fitting.”

It should be understood, of course, that the foregoing relates to exemplary embodiments of the invention and that modifications may be made without departing from the spirit and scope of the invention as set forth in the following claims.

We claim:

1. A plumbing fitting comprising:
an elongate body defining a through bore having a centerline, said body providing for sealing connection of respective end termination portions of opposite pipes into respective opposite ends of said through bore;
said body also defining an orthogonal branch boss disposed intermediate of opposite ends of said elongate body and providing a branch bore opening on said orthogonal boss and communicating with said through bore and having a respective centerline, said body providing for sealing connection of a respective branch pipe end termination portion into said branch bore;
wherein said respective centerline of said branch bore is offset from said through bore centerline in end elevation view of said body, and intersects orthogonally with said through bore centerline in side elevation view.

2. The plumping fitting of claim 1, wherein said through bore is stepped in order to provide a pair of oppositely disposed pipe sockets for adhesively sealingly receiving opposite end termination portions of respective opposite PVC pipes.

3. The plumping fitting of claim 1, wherein said branch bore is stepped to provide a orthogonal pipe socket for adhesively sealingly receiving an end termination portion of a branch PVC pipe.

4. The plumping fitting of claim 1, wherein said body defines plural orthogonal branch bosses spaced along said body between opposite ends thereof, and each of said orthogonal branch bosses defining a respective branch bore and providing for sealing connection of a respective branch pipe end termination portion into said respective branch bore.

5. A method of arranging a plumbing apparatus, said method comprising steps of:
providing a T-fitting in a run of pipe;
providing a branch pipe orthogonally connecting in flow communication with said run of pipe via said T-fitting;
offsetting said branch pipe so that a centerline of said branch pipe does not intersect a centerline of said run pipe in end elevation view, but so that said centerlines do intersect orthogonally in side elevation view of said run and branch pipes.

6. The method of claim 5 further including the steps of forming said run pipe and said branch pipe and said T-fitting of PVC, and adhesively bonding said run pipe and said branch pipe to said T-fitting.

7. An offset T-fitting especially configured to install a plumbing arrangement in a wall of a swimming pool or spa, said offset T-fitting comprising:
an elongate tubular body of PVC material, said elongate body defining a through bore having a centerline, and said body at opposite ends of said through bore providing for sealing connection to said body to respective opposite end termination portions of connecting run pipes;
intermediate of said opposite ends of said elongate body said offset T-fitting also defining an orthogonal branch boss extending outwardly on said elongate body, said orthogonal branch boss providing a branch bore opening on said orthogonal boss and communicating with said through bore and having a respective centerline, said body providing for sealing connection of a respective branch pipe end termination portion into said branch bore; and
said respective centerline of said branch bore being offset from said through bore centerline in end elevation view of said body along said through bore, and said respective centerline intersects orthogonally with said through bore centerline in side elevation view of said offset T-fitting.

8. The offset T-fitting of claim 7, wherein said through bore is stepped in order to provide a pair of oppositely disposed pipe sockets for adhesively sealingly receiving opposite end termination portions of respective opposite PVC pipes.

9. The plumping fitting of claim 7, wherein said branch bore is stepped to provide a orthogonal pipe socket for adhesively sealingly receiving an end termination portion of a branch PVC pipe.
